(19) United States
(12) Patent Application Publication
(10) Pub. No.: US 2002/0010526 A1
(43) Pub. Date: Jan. 24, 2002

(54) Method for providing a three-dimensional model

(76) Inventors: Ryuya Ando, Hitachi (JP); Kikuo Umegaki, Hitachinaka (JP); Takashi Okazaki, Hitachinaka (JP); Tarou Takagi, Hitachi (JP)

Correspondence Address: DICKSTEIN SHAPIRO MORIN & OSHINSKY LLP, John C. Luce, 2101 L Street NW, Washington, DC, 20037-1526, US

(21) Appl. No.: 09/839,359

(22) Filed: Apr. 23, 2001

(30) Foreign Application Priority Data
Jul. 13, 2000 (JP) 2000-217203
Jan. 26, 2001 (JP) 2001-17819

(51) Int. Cl. G06F 19/00

(52) U.S. Cl. 700/118; 700/163; 700/98

(57) ABSTRACT

The present invention provides a method for providing a three dimensional model based upon an instruction of a client including storing a three dimensional object image data provided by a client and extracting a three dimensional model image data from the object image data and producing the three dimensional model with the model image data and providing the client with the three dimensional model.

### FIELD OF THE INVENTION

The present invention relates to a method for providing a three-dimensional model, more particularly, a method for providing a three dimensional model utilizing an image data.

### DISCUSSION OF THE RELATED ART

Many techniques for providing a three dimensional model are known. But, most techniques require the client or customer to bring the object to a three dimensional model provider, making it difficult or unfeasible for the client to model an object having a heavy and/or large size. Also, if an object to be modeled is attached to, or obstructed by, other unwanted objects, the object image data for the desired object would also include image data for the undesired components. For instance, if an object image data is obtained for an organ of a living body, such as a brain or stomach, it would include other information other than the object to be modeled (e.g. skull, ribs, etc.). Thus, the three dimensional object image data typically provided is insufficient to be processed by a three dimensional modeling device. Hence, a client is required to provide lengthy, complicated instructions for data extraction of a model image data.

### SUMMARY OF THE INVENTION

The present invention provides a method for providing a three-dimensional model, which is capable of efficiently providing a desired three-dimensional model for a client utilizing the three-dimensional object image data containing the desired object image to be modeled, irrespective of size or shape.

In an object of the present invention, a method for providing a three dimensional model is provided. The steps comprise storing a three dimensional object image data provided by a client and extracting a three dimensional model image data from the object image data. The invention further includes producing the three dimensional model with the model image data and providing the client with the three dimensional model.

In another embodiment of the present invention, a method for providing a three dimensional model is provided including the steps of storing a three dimensional object image data provided by a client and extracting a three dimensional model image data from the object image data. The invention further includes the steps of providing a three dimensional model provider with the model image data for producing the three dimensional model with the model image data and providing the client with the three dimensional model.

In another embodiment of the present invention, a method for providing a three dimensional model is provided including the steps of receiving a three dimensional object image data from a client and providing an image analysis provider with the object image data for extracting a three dimensional model image data from the object image data. The invention further includes the steps of providing a three dimensional model provider with the model image data for producing the three dimensional model with the model image data and providing the client with the three dimensional model.

In another embodiment of the present invention, a method for providing a three dimensional model is provided including the steps of imaging a three dimensional object to obtain a three dimensional object image data and storing the three dimensional object image data. The invention further includes the steps of extracting a three dimensional model image data from the object image data and producing the three dimensional model with the model image data and providing the client with the three dimensional model.

In yet another embodiment of the present invention, a method for providing a three dimensional model is provided including the steps of storing a three dimensional object image data provided by a client and extracting a three dimensional model image data from the object image data. Also, the invention includes the step of providing the client with the model image data.

In yet another embodiment of the present invention, a method for providing a three dimensional model is provided including the steps of receiving a three dimensional object image data from a client and providing an image analysis provider with the object image data for extracting a three dimensional model image data from the object image data. Next, the invention includes providing the client with the model image data.

In another embodiment of the present invention, a method for providing a three dimensional model is provided including the steps of imaging a three dimensional object to obtain a three dimensional object image data and storing the three dimensional object image data. Further, the invention includes extracting a three dimensional model image data from the object image data and providing the client with the model image data.

### BRIEF DESCRIPTION OF THE DRAWINGS

The above advantages and features of the invention will be more clearly understood from the following detailed description which is provided in connection with the accompanying drawings.

FIG. 1 is a schematic diagram illustrating a first embodiment of a method for providing a three-dimensional model according to the present invention;

FIG. 2 is a flowchart illustrating an example of the processing for identifying a customer to proceed to the next service;

FIG. 3 is a flowchart illustrating an example of the ordering steps shown in FIG. 2;

FIG. 4 is a flowchart illustrating an example of a method for specifying instruction information;

FIG. 5 is a flowchart illustrating another example of a method for specifying instruction information;

FIG. 6 is a flowchart illustrating an example of the information providing steps shown in FIG. 2;

FIG. 7 is a diagram illustrating an example of processing for extracting a region of interest by an image processing device in the first embodiment;

FIG. 8 is a schematic diagram illustrating a second embodiment of a method for providing a three-dimensional model according to the present invention;

FIG. 9 is a schematic diagram illustrating a third embodiment of a method for providing a three-dimensional model according to the present invention;

FIG. 10 is a flowchart illustrating an example of a method for extracting a region of interest according to the present invention;

FIG. 11 is a schematic diagram illustrating a photo modeling device;

FIG. 12 is a diagram illustrating an example of converting image B into layered images;

FIG. 13 is a schematic diagram illustrating the photo modeling steps; and

FIG. 14 is a schematic diagram illustrating a fourth embodiment of a method for providing a three-dimensional model according to the present invention.

### DETAILED DESCRIPTION OF THE INVENTION

Exemplary embodiments of the present invention will be described below in connection with the drawings. Other embodiments may be utilized and structural or logical changes may be made without departing from the spirit or scope of the present invention. Like items are referred to by like reference numerals throughout the drawings.

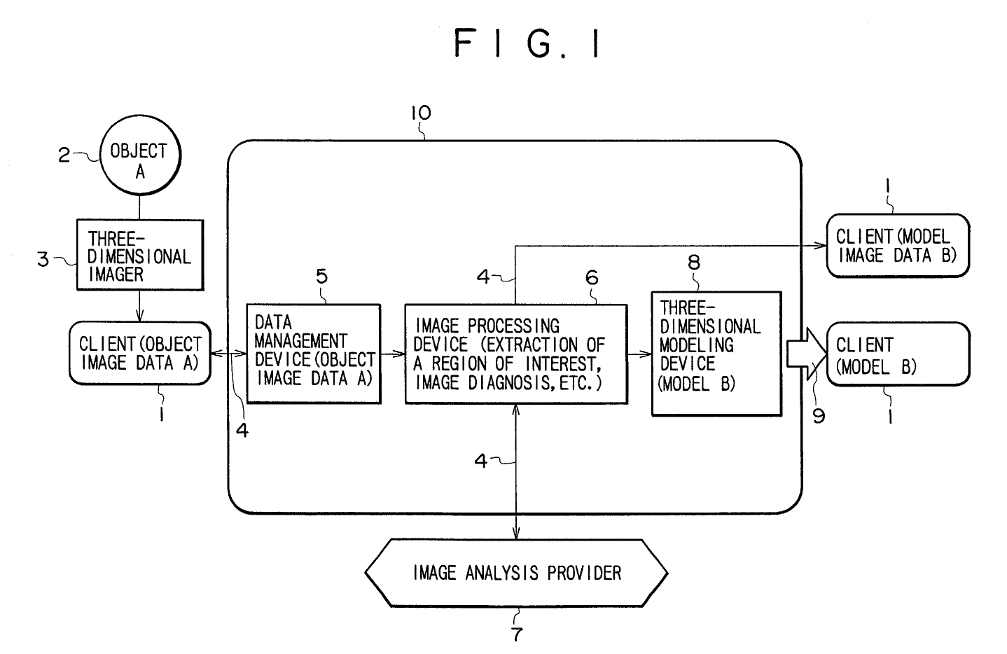

Referring now to FIG. 1 is a schematic diagram illustrating a first embodiment of a method for providing a three-dimensional model according to the present invention. In this embodiment, a client 1 obtains a three-dimensional object image data A (hereinafter referred to as “object image data A”) of an object 2, which includes the desired object to be modeled, using a three-dimensional imager 3. The client 1 can transmit the object image data A and instruction information about modeling (hereinafter referred to as “instruction information”) to a service provider 10. Service provider 10 provides all the functions necessary to accomplish the object of the invention in all its embodiments.

As a method for providing the object image data A, for example, it is possible to send the object image data A in a storage medium such as a floppy disk, an optical disk, or the like by mail. Also, it is possible to bring the object image data A in some storage medium directly to the service provider 10. Preferably, object image data A is transmitted through a network 4, such as by e-mail, since it provides a high rate of data transmission and consequently shortens delivery time. As a method for providing the instruction information, it may be informed by telephone, by fax, by mail, or in person.

The instruction information can be broad, specifying only a purpose of modeling and a use for the modeled object. Alternatively, detailed information specifying a region for modeling, quality of material (material) for the modeled object, color, and the like can be provided. For instance, a whole image portion, a specific region of interest (a specific region of a human body) or the like are specified.

Also, if the client 1 has a request for a three-dimensional model that was supplied by the service provider 10 in the past, the client 1 can inform the service provider 10 of such information as instruction information. For example, client 1 can transmit information about a customer number, a previous order number, a request, and the like through a terminal (network terminal) connected to the network 4, thereby, eliminating the need for other detailed information. Thus, if the client 1 requests a three-dimensional model again, process time can be expedited.

The service provider 10 stores the object image data A and the instruction information, which have been provided by the client 1, using a data management device 5. Also, the service provider 10 determines estimates about charge, delivery and the like, according to the description of the request from the client 1 using the data management device 5 and transmits the estimation information to the client 1 through the network 4. Further, the data management device 5 manages information about the production progress of the object to be modeled. The production progress information is also transmitted to the client 1 via the network 4.

The object image data A stored in the data management device 5 is processed in an image processing device 6 according to the instruction information of the client. For example, if the client 1 provides a three-dimensional CT (computerized tomography) image of a human body to request modeling of a stomach, a stomach image data is extracted using image processing software or the like. Thus, only a simple instruction identifying a region of any body or object, either animate or inanimate, (e.g. human, animal, etc.) permits an appropriate image processing method to be selected.

Also, if complicated instruction is received from the client 1, client 1 may request an independent image analysis provider 7 to perform such processing as necessary. In this case, the service provider 10 provides the image analysis provider 7, via the network 4, with three-dimensional object image data A that relates to an object to be modeled. Then, the service provider 10 obtains a model image data B from the image analysis provider 7.

The three-dimensional model image data B that relates to the object to be modeled, and that has been extracted by the image processing device 6, is transmitted to a three-dimensional modeling device 8. The three-dimensional modeling device 8 shapes the desired object to be modeled using appropriate quality of material according to the purpose of modeling or the use of the modeled object or using the quality of material specified by the client 1. Hereinafter, a modeled object produced according to the model image data B is referred to as a model (three-dimensional model) B.

As the three-dimensional modeling device 8, for example, a device using layered manufacturing including for example laser photo lithography, selective laser sintering, fused deposition method, rapid prototyping can be utilized. In addition, a device using ultrasonic fabrication, or the like, can also be utilized. If these devices are used, materials, such as, resin, metal, rubber, and the like, can be used as quality of material. Additionally, the model B can be colored as necessary.

The layered manufacturing is a method that laminates small material bodies in layers to form a desired shape. For example, in the laser photo lithography method, a desired model is obtained by irradiating resin in a liquid state (which cures by irradiation with ultraviolet light) with a ultraviolet-light laser beam to solidify the liquid surface (the resin is hereinafter referred to as “photocuring resin”) and repeating it to form several layers.

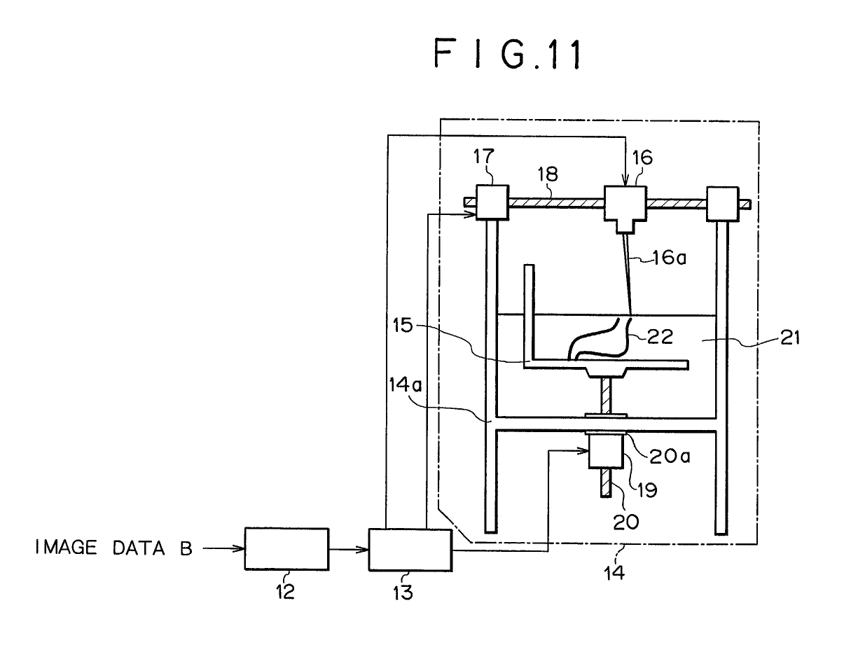

A method for producing the model B by means of the laser photo lithography is specifically described with reference to FIGS. 11 through 13 as below. As shown in FIG. 11, this photo modeling device comprises a storage device 12, a processor 13, and a modeling device body 14. The storage device 12 stores the model image data B. The processor 13 processes model image data B to provide data regarding each of the successive layers which make up the model image data B. Also, processor 13 controls the modeling device body 14. The modeling device body 14 irradiates photocuring resin 21 with ultraviolet light 16a selectively to cure this resin by polymerization according to the data of the layers determined by the processor 13.

The modeling device body 14 comprises a resin bath 14a for storing photocuring resin 21 in a liquid state, a table 15 on which an object to be modeled is placed, an ultraviolet-light irradiation means 16 for irradiating ultraviolet light 16a, a first scanner 17 for moving the ultraviolet-light irradiation mean 16, and a second scanner 19 for moving the table.

The processor 13 controls operation of the ultraviolet-light irradiation means 16, the first scanner 17 and the second scanner 19 according to the data of the layers. The processor 13 also includes power supplies for the ultraviolet-light irradiation means 16, the first scanner 17 and the second scanner 19 which may be installed separately from the processor 13.

The model B is produced by the following steps:

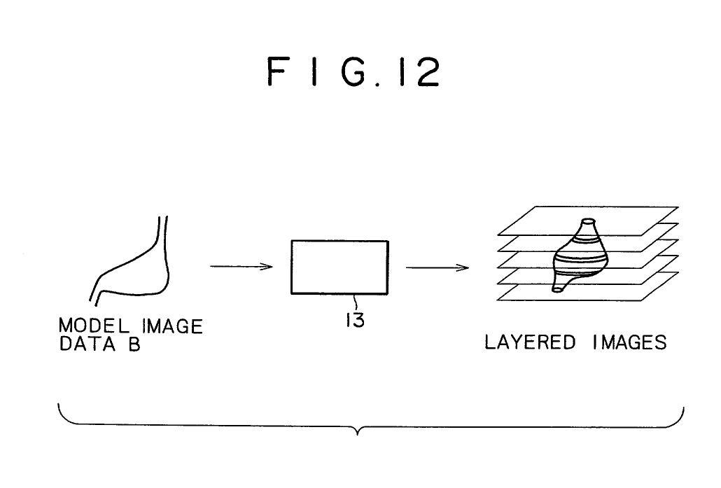

(1) The processor 13 processes the data which make up the layers of model image data B, stored in storage device 12. Each of the data corresponds to each image-data layer, into which the model image data B has been divided. FIG. 12 is a diagram illustrating how these image layers are determined from the image data B. Note, FIG. 12 only illustrates five layers to simplify the diagram.

(2) The processor 13 sets a position of the ultraviolet-light irradiation means 16 to a position corresponding to the data of the image layers by controlling the first scanner 17 and irradiates the photocuring resin 21 with the ultraviolet light 16a from the ultraviolet-light irradiation means 16.

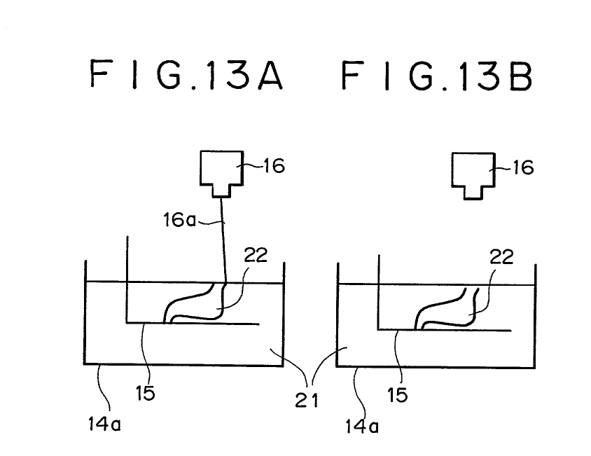

In this case, the ultraviolet-light irradiation means 16 moves above a first ball screw 18 and a second ball screw 20. The ultraviolet-light irradiation means 16, therefore, has a configuration being capable of moving back and forth, and right and left. In this manner, a region to be modeled on the photocuring resin 21, which corresponds to the data of the image layers is irradiated with the ultraviolet light 16a to cure the irradiated region. FIG. 13A shows the cured region by a reference number 22.

(3) Next, the processor 13 moves the table 15 down by a height equivalent to one layer of data images to generate new photocuring-resin liquid layer by controlling the second scanner 19. In this case, because the table 15 is secured to the upper end of a second ball screw 20, the table 15 moves together with the second ball screw 20. A sealing means 20a, for preventing leakage of photocuring resin in a liquid state, is attached where the second ball screw 20 extends through the resin bath.

(4) Model B is produced by repeating (2) and (3) the number of times equivalent to the number of the layers that has been determined by the processor 13.

As described above, since the layered manufacturing enables us to form a complicated model integrally, the layered manufacturing is suitable for three-dimensional modeling according to the present invention.

The ultrasonic fabrication is a method that uses resin containing scattered micro-capsules in which cure-reaction catalyst are provided. In this method, ultrasonic waves, which focus on a specific point inside the resin, breaks down the micro-capsules, causing the points to cure. This method eliminates the need for mechanical scanning. Hence, it is possible to shape rubber photocuring resin without using support material. Additionally, very quick modeling also becomes possible.

The model B, which has been produced by the three-dimensional modeling device 8, is delivered to the client 1 by a transportation means 9 including hand delivery or via mail. In addition, if there is a special instruction from the client 1, the model image data B processed by the image processing device 6 can be delivered to the client 1 via the network 4, via mail in a storage medium, etc., without producing the model B by the three-dimensional modeling device 8. Also, both of the model B and the model image data B can also be delivered to the client 1.

In this manner, by extracting the model image data B of the object to be modeled from the object image data A based on the instruction information provided by the client 1, and by producing the model B using the extracted model image data B, it is possible to expedite data transmission from the image processing device 6 to the three-dimensional modeling device 8 and production of the model B by the tree-dimensional modeling device 8. The client 1, therefore, can obtain the desired three-dimensional model in an expedited manner.

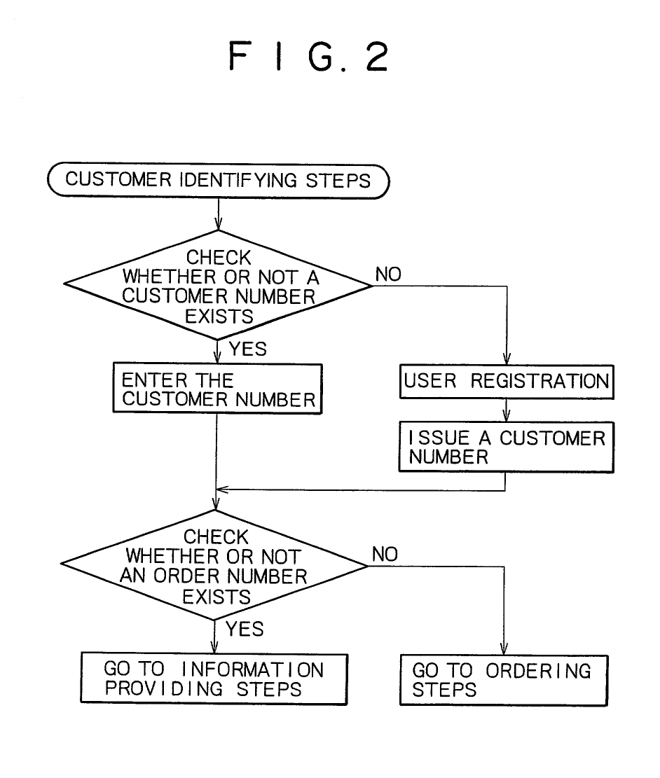

The following describes processing steps of the first embodiment according to the present invention in more detail. FIG. 2 is a flowchart illustrating an example of processing for identifying a customer (a client) to proceed to the next service.

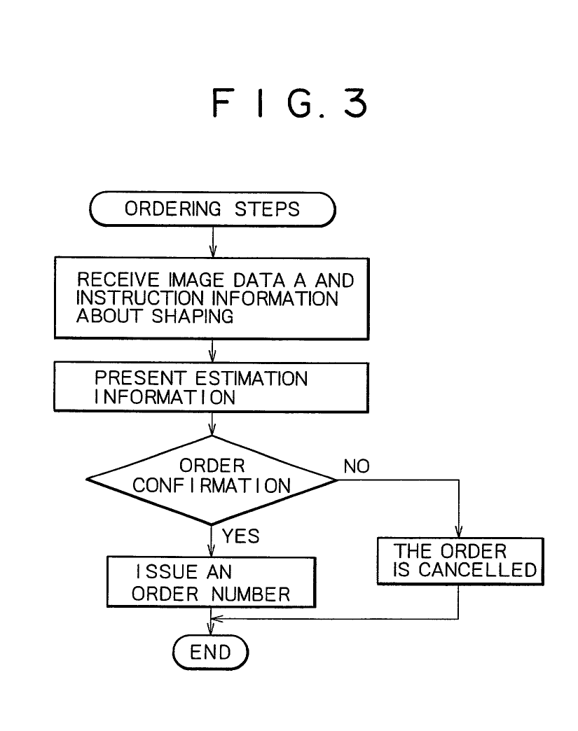

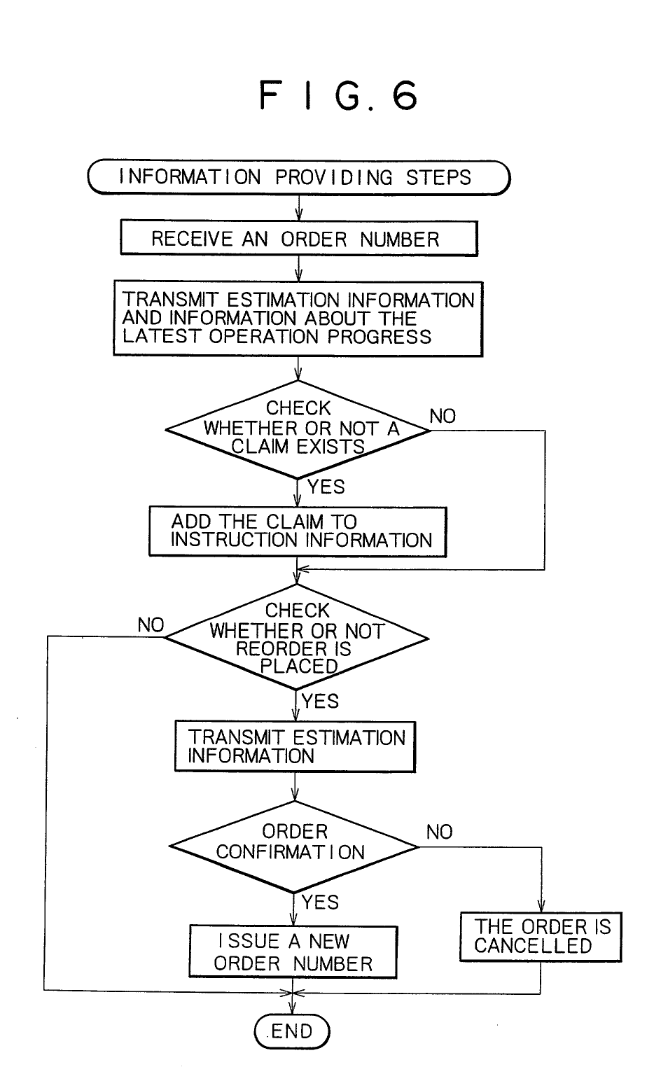

As shown in FIG. 2, if the customer has a customer number, the customer enters the customer number in a network terminal and then proceeds to the next operation. If the customer has no customer number, the customer makes an entry in the network terminal to perform user registration and receives a customer number issued by the data management device 5 of a service provider before proceeding to the next operation. Next, a check is performed to determine whether or not a customer number exists. If the customer does not have an order number, the customer proceeds to ordering steps shown in FIG. 3. If the customer has an order number, the customer proceeds to information providing steps shown in FIG. 6. In this manner, the customer is managed by the customer number and the order number.

FIG. 3 is a flowchart illustrating an example of the ordering steps. In the ordering steps, the service provider 10 receives object image data A and instruction information about modeling from the client 1 and then transmits price estimates and delivery time to client 1. If the client 1 is satisfied with the estimation information, the service provider 10 receives an order confirmation from the customer and issues an order number and then transmits it to the client 1. However, if the client 1 is not satisfied with the estimation information, the service provider receives information of unaccepted order confirmation from the client 1 and the order is cancelled. Such data processing is managed by the data management device 5.

The order from the client 1 described above can be received, for example using a network terminal 4 or an input terminal installed at a place for acceptance, a transmission of an application form or by oral instruction, and the like.

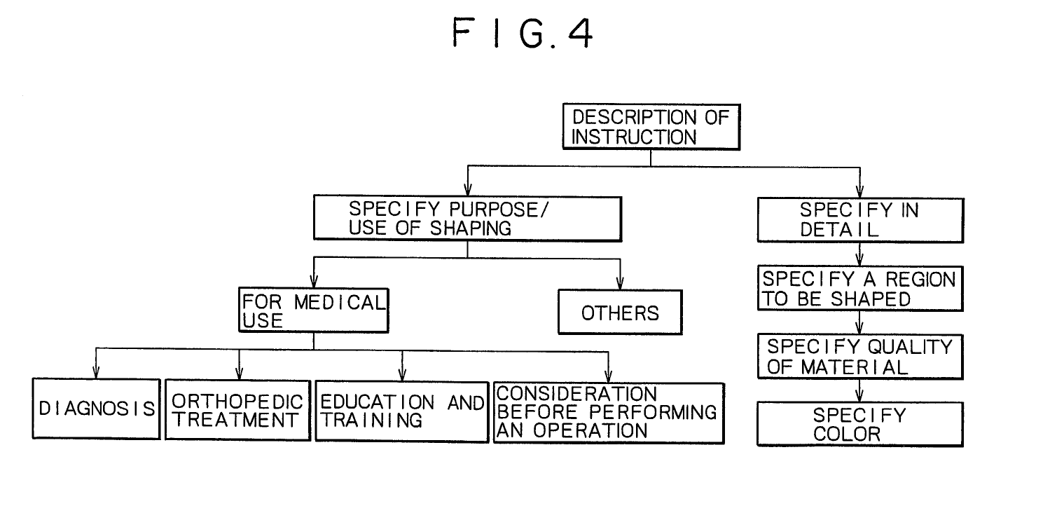

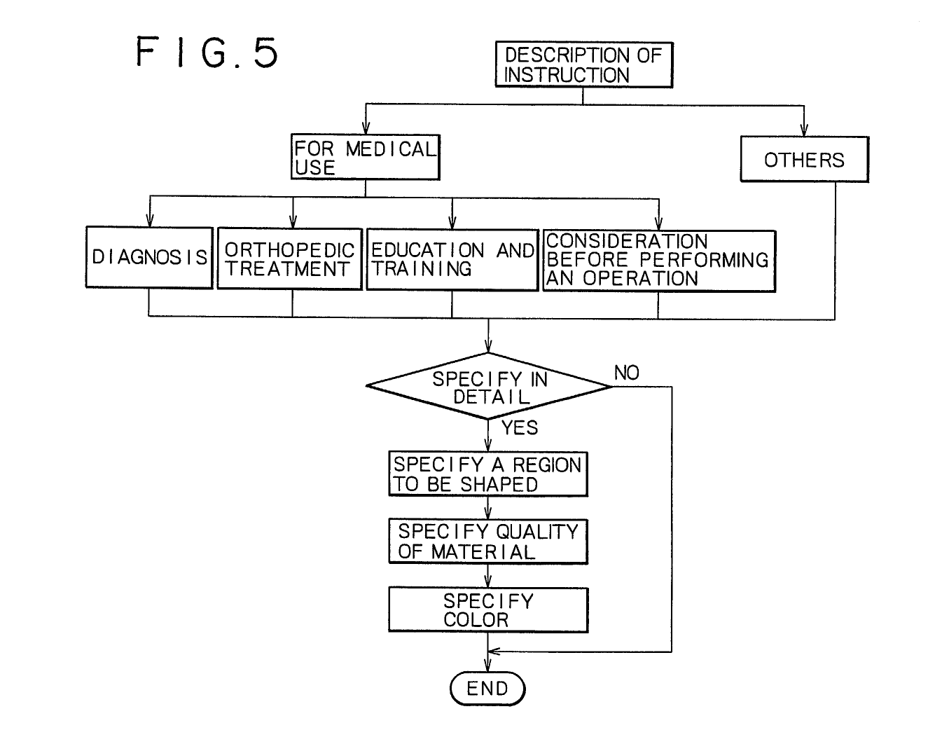

Next, with reference to FIG. 4 and FIG. 5, a method for specifying instruction information about modeling will be described. FIG. 4 is a flowchart illustrating an example of the method for specifying instruction information. FIG. 5 is a flowchart illustrating another example of the method for specifying instruction information.

Referring now to FIG. 4, one of the following choices is selected, either specifying a purpose of modeling and a use of the modeled object, or specifying information in more detail is selected. For example, if the object image data A is medical image data, it is possible to specify only the use such as “consideration before performing an operation,” “education and training,” “orthopedic treatment,” and “diagnosis.” In addition, if more detailed specification is selected, a portion (for example, a specific region of a human body, such as the hips or ribs) that is desired to be modeled from the object image data A, quality of material, color, and the like are specified.

For example, if the client 1 is a doctor who intends to perform operation to remove stomach tumors, the client 1 selects “medical use” and then “consideration before performing operation.” The service provider 10 selects rubber as quality of material, and red for a stomach and black for tumors to be colored, for example, according to the instruction information about this use. In this case, a material that enables the doctor to gain an experience similar to an actual operation at the time of a simulated operation is selected as quality of material.

In this manner, the client 1 receives information about the quality of material and the color, which have been selected by the service provider 10, via the network 4. If the client 1 is not satisfied with the quality of material and the color, the client 1 is allowed to select the detailed specification. The client 1 can specify claim information as new information: for example, resin as quality of material, non-color for a stomach and others.

If the client 1 selects instruction information of “medical use” and then “education and training” as use, the service provider 10 can select rubber as quality of material, red for a stomach, black for tumors, and its surrounding area to be colored, for example. In this case, as quality of material, a material that enables the doctor to provide an experience similar to an actual organ should be selected. In addition, since the purpose of “education and training” is selected, it is assumed that a case is typical or specific. Therefore, colors that permit a diseased region and its surrounding characteristics to be distinctly identified are selected.

If the client 1 selects instruction information of “medical use” and then “orthopedic treatment” as use, the service provider 10 selects metal as quality of material and non color as color, for example. If a purpose is “orthopedic treatment”, it is assumed that an model to be extracted is a hard tissue like a bone and that the object to be extracted is used as a mold of orthopedic member. Accordingly, as quality of material and color, those suitable for such use are selected.

If the client 1 selects instruction information of “medical use” and then “diagnosis” as use, the service provider 10 selects resin as quality of material and non-color as color, for example. In the case of “diagnosis” use, selected quality of material and color are those that enable the doctor to identify a position and a size of diseased region easily and that resist deformation (or breakage).

In this connection, a use other than the medical use, such as extraction of a fossil, and its modeling in archaeology, for example, can be specified as other items for the use specification.

Next, an example of a detailed instruction will be described utilizing client 1 who is a doctor and wants to obtain training in endoscope operation. If the object image data A covers a portion from the head to the abdominal region, the client 1 specifies a whole path of the endoscope from the mouth to the stomach as a modeling portion and also specifies rubber as quality of material and pink as color. The service provider 10 extracts the model image data B, which corresponds to the modeling portion, from the object image data A based on the detailed instruction information from the client 1.

FIG. 5 illustrates an embodiment where, details are specified after specifying a purpose of modeling and a use of an object. However, if the details are not desired to be specified, they can also be omitted. In the case of FIG. 5, if stomach operation is taken as an example, after specifying “medical use” and then “consideration before performing an operation,” it is possible to specify the detail, for example, changing the color of tumors to yellow.

Next, with reference to FIG. 6, a method for providing information from a service provider to a customer (a client) will be described. Upon receiving an order number from the customer via a network 4, the service provider 10 provides the customer, via the network 4, with estimation information corresponding to this order number and information about the latest operation progress. In other words, the service provider 10 provides the client 1 with a progress report of the model. Then, upon receiving new information (such as a claim) from the customer, the service provider adds this new information to the instruction information from the customer and stores it.

If the customer wants to change the instruction information about modeling, the customer can change it again according to steps shown in FIGS. 4 and 5 after receiving estimation information and information about the latest operation progress from the service provider. For example, in the case of a stomach operation, when extraction of a wider portion is required because an initially extracted portion is not sufficient, such required portion for modeling is specified in the detailed instruction. Such specifying can be provided by, text or graphics, a predefined menu, or the like. When the service provider receives such claim information from the customer, the service provider changes the instruction information about modeling according to the claim information.

In addition, if the service provider receives information requiring a reorder (an additional order) from the customer, the service provider transmits estimation information for the reorder to the customer. In response to the estimation information, if the service provider receives information of order confirmation from the customer, the service provider issues a new order number and transmits it to the customer. In addition, the service provider associates the object image data A and the instruction information, which correspond to the original order number, with the new order number, and stores them.

Thus, in the case of reorder, because the customer can eliminate the need for transmitting the object image data A and the instruction information again, procedures become simpler. On the other hand, if information of unaccepted order confirmation is received from the customer, the reorder processing is cancelled. This data processing is also managed by the data management device 5. As described above, the information providing steps terminate. Note, the invention can also search the database to provide a model image data B for any prospective customer if there is one available and approved by the client 1.

In this manner, the client 1 can get an update on the operation progress at any time, and can transmit information such as a claim to the service provider at any time. Therefore, the model desired by the client 1 can be obtained reliably.

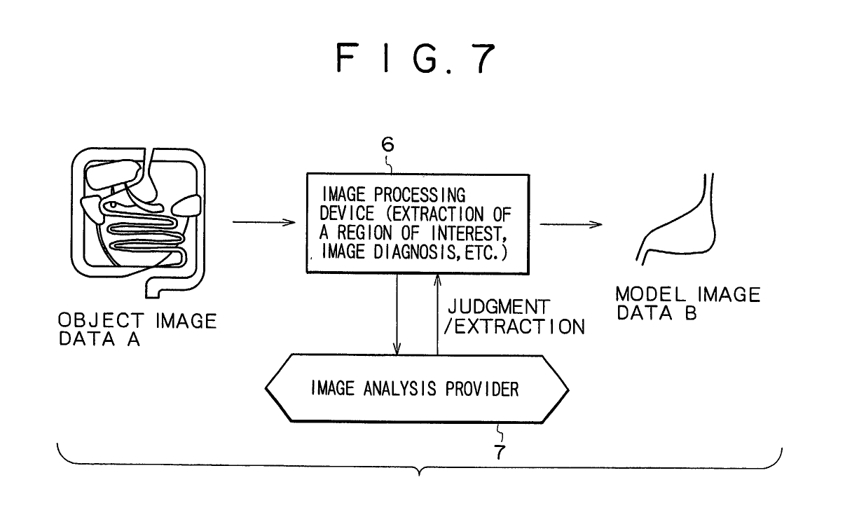

Next, with reference to FIG. 7, an example of processing for extracting a region of interest by the image processing device 6 will be described. In this example, the image processing device 6 extracts the model image data B of a stomach from the object image data A containing organs of a human body, which has been provided by a client 1, according to instruction information by the client. When performing this extraction processing, if specialized identification of a localized position is required, such as a node, the service provider 10 may request an image analysis provider 7 to identify such node and to extract the region of interest.

As a method for extracting the model image data B of a stomach from the object image data A using the image processing device 6, for example, one of the following (or a combination of them) can be used:

(1) Threshold value processing: setting a threshold value for differentiating between a stomach as a region of interest and other portions; and extracting only the region of interest according to the threshold value.

(2) Edge extraction processing: extracting a contour shape of a stomach according to shading distribution of the image.

(3) Creating a function image from the object image data A, and extracting the model image data B by mask processing using a mask pattern according to the function image.

In this case, the function image means an image containing information that is different from an original. For example, the function image includes an image created by the following steps: determining a change with time of a density value at each point (each pixel) of the original image and calculating various parameters such as a peak value at that point and an arriving time to the peak value. Then, these parameters are converted into shading information.

Creating the function image in this manner permits portions having the same function in an image to be extracted distinctly. In the case of a digestive system like a stomach, after a person or patient drinks a “tracing” fluid (e.g. barium mush) its change with time is recorded in a CT image and a portion corresponding to a barium flow path can be extracted. Mask processing of the extracted image as a masking pattern permits a stomach portion to be extracted from the three-dimensional CT image as the original image.

(4) Watershed method: modifying the object image data A into a watershed shape; and extracting a portion by means of a watershed method.

In this case, shading distribution of an image used in the watershed method is similar to puddles that are formed in places having a low altitude if the shading distribution is regarded as altitudes in topography. When extracting a stomach from the three-dimensional CT object image A, a broad contour of the stomach is extracted by edge extraction processing, and the like. In this case, if the contour is extracted in such a manner that a density value of a contour portion becomes relatively high, and a density value of an inside portion of the stomach becomes relatively low, it is possible to make a (three-dimensional) puddle in the inside portion of the stomach. This shape is called a watershed shape. Hence, a model of the stomach is extracted by increasing or decreasing quantity of water to be put into this puddle to adjust a water surface level, in other words, by adjusting a threshold value of a shading value for the watershed shape. This method enables extraction of a portion for which continuous contour lines are ensured.

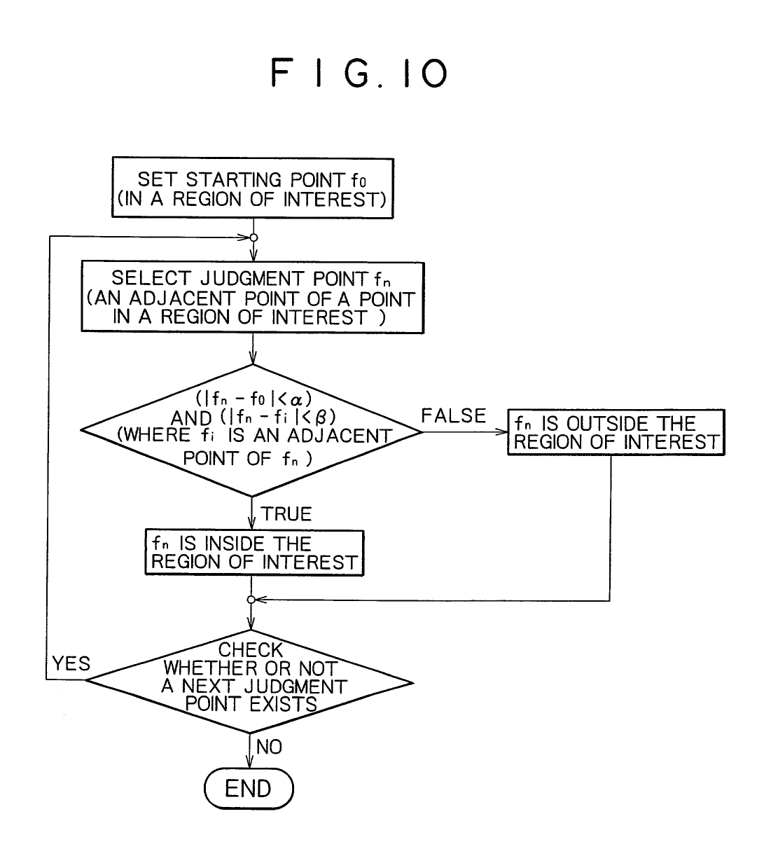

As an example, a method for extracting a region of interest by means of region growing algorithm, which is a combination of threshold value processing and edge extraction processing, will be described as below. FIG. 10 is a flowchart illustrating a method for extracting a region of interest using region growing algorithm. The object image data A is expressed in a density value for each pixel of the image. In the region growing algorithm, by focusing attention to this point, the region of interest is extracted by the following steps:

(1) Setting a starting point (a starting pixel) in a region of interest, and assuming that a density value of this pixel is f₀.

(2) Selecting a pixel (a judgment pixel) adjacent to a pixel that has been judged to be in the region of interest and (assuming that a density value of this judgment pixel is fₙ) determining a difference between fₙ and f₀ (¦fₙ−f₀¦), and a difference between fₙ and a density value fᵢ of a pixel adjacent to the judgment pixel (¦fₙ−fᵢ¦).

(3) If (¦fₙ−f₀¦<α) and (¦fₙ−fᵢ¦<1), this judgment pixel is judged to be inside the region of interest. If neither of the conditions are satisfied, this judgment pixel is judged to be outside the region of interest. α is a threshold value making it a condition that a density difference between pixels in the same portion is within a given range. β is a threshold value making it a condition that a density difference between pixels adjacent to one another is small and within a given range.

(4) Repeating (2) and (3) for all pixels that are adjacent to pixels in the region of interest.

Thus, the region growing algorithm is a method for extracting a whole required portion by performing region growing while capturing an adjacent portion considered to belong to the same portion. This method enables service provider 10 to extract a portion for which continuous contour lines are ensured. In this connection, α and β described above can be predetermined empirically or experimentally.

In the manner described above, the service provider 10 can provide the client 1, in an expedited manner, with the model B produced based on the object image data A and the instruction information about modeling, which have been provided by the client 1.

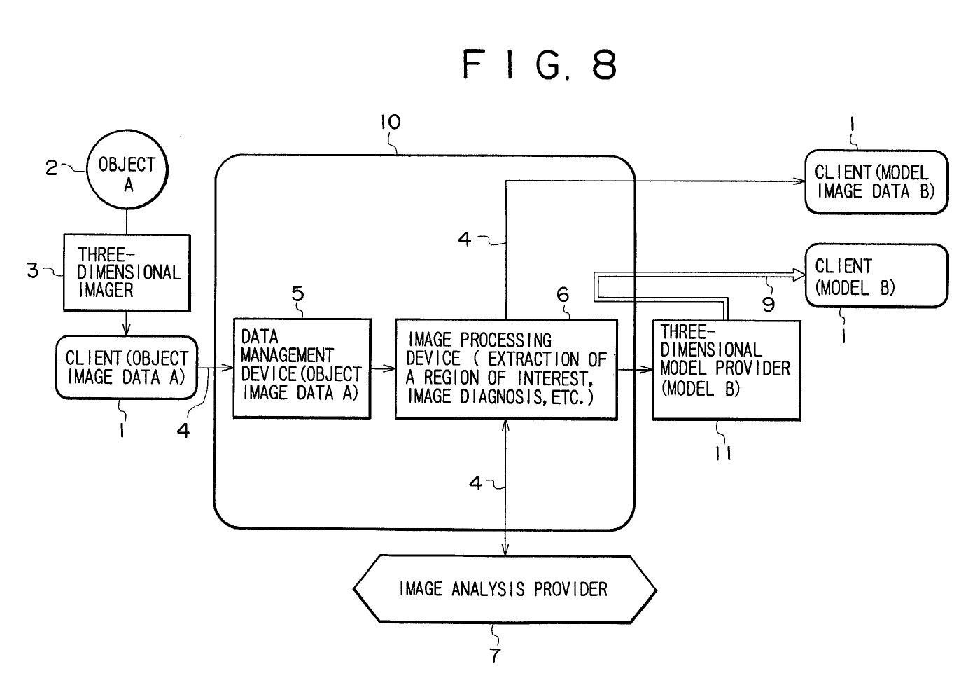

Next, with reference to FIG. 8, a second embodiment of the method for providing a three-dimensional model according to the present invention will be described. The difference between this embodiment and the first embodiment is that the service provider 10 requests an three-dimensional model provider 11 (independent model maker utilizing model image data B) to produce the model B. In this embodiment, the service provider 10 provides a three-dimensional model provider 11, via the network 4, via mail in a storage medium, etc., with the model image data B extracted by the image processing device 6. Then, the service provider 10 requests the three-dimensional model provider 11 to produce the model B. After that, the service provider 10 obtains the model B from the three-dimensional model provider 11, and delivers the model B to the client 1. In this case, business description of the service provider 10 includes receipt of order from the client, image data processing, information management, operations management, and delivery. In the case of this embodiment, selecting the proper three-dimensional model provider 11 by the service provider 10 according to instruction from the client 1 enables the client 1 to obtain the desired three-dimensional object in an expedited manner.

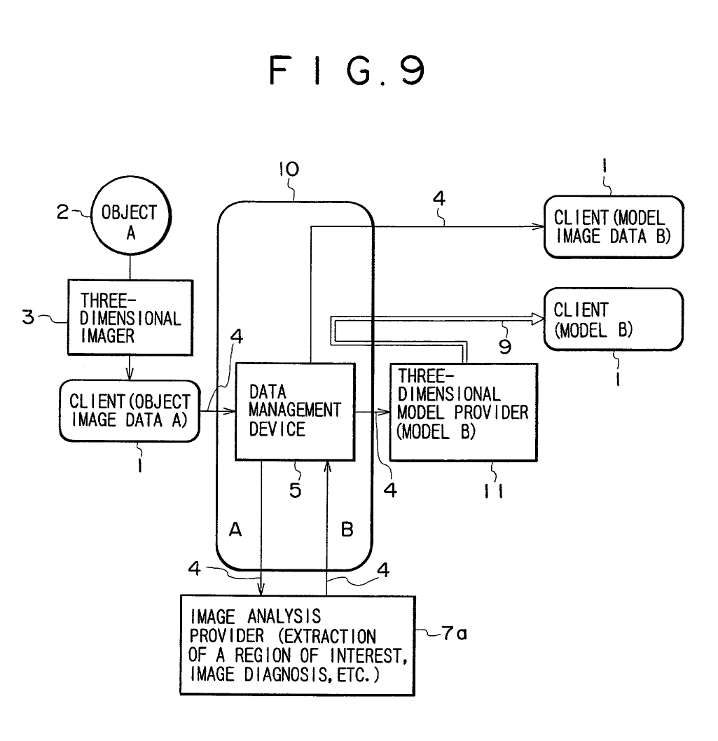

Next, with reference to FIG. 9, a third embodiment of the method for providing a three-dimensional model according to the present invention will be described. The difference between this embodiment and the second embodiment is that the service provider 10 requests an image analysis provider (an independent object image data A analyzer) 7a to extract the model image data B. In this embodiment, the service provider 10 provides the image analysis provider 7a, via the network 4, with the object image data A and instruction information that have been provided by the client 1 and then obtains the model image data B from the image analysis provider 7a. In this case, business description of the service provider 10 consists of receipt of order from a client, information management, operations management and delivery. According to this embodiment, an effect similar to that of the second embodiment can be achieved. Moreover, in the case of this embodiment, the client 1 can also obtain a result of the object image processing based on specialized knowledge of the image analysis provider 7a.

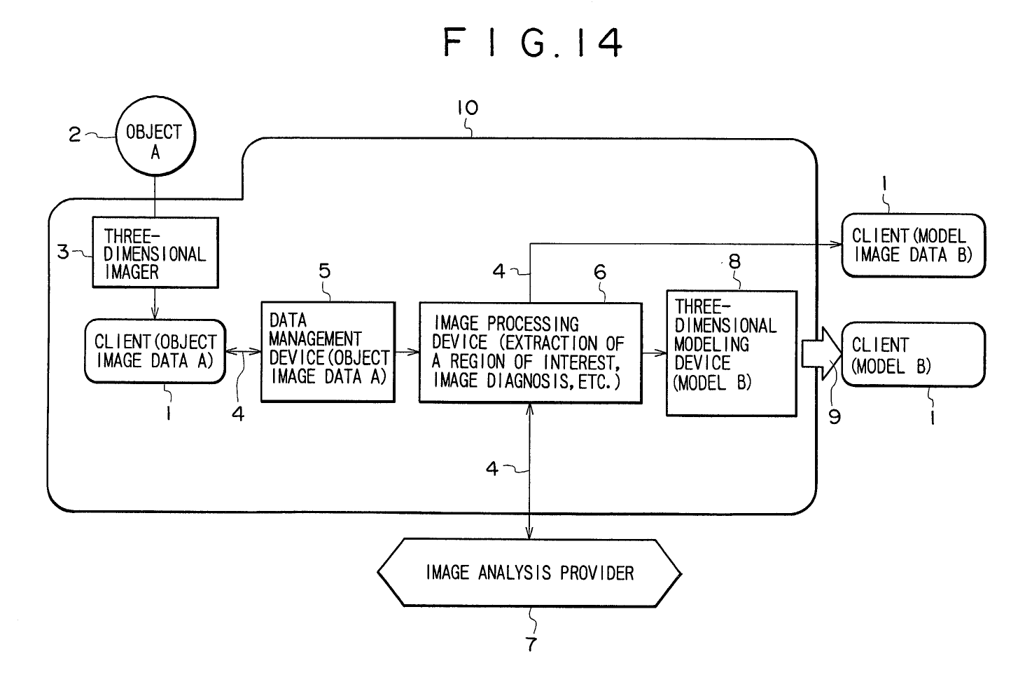

Next, with reference to FIG. 14, a third embodiment of the method for providing a three-dimensional model according to the present invention will be described. The difference between this embodiment and the first embodiment is that the service provider 10 images the object to be modeled utilizing the three dimensional imager 3. Hence, the client 1 need not provide an object image data A, but, only the object to be imaged and modeled. In this case, business description of the service provider 10 includes receipt of order from the client, image data processing, information management, operations management, and delivery. In the case of this embodiment, selecting the proper three-dimensional model provider 11 by the service provider 10 according to instruction from the client 1 enables the client 1 to obtain the desired three-dimensional object in an expedited manner.

Although the invention has been described above in connection with exemplary embodiments, it is apparent that many modifications and substitutions can be made without departing from the spirit or scope of the invention. Accordingly, the invention is not to be considered as limited by the foregoing description, but is only limited by the scope of the appended claims.

What is claimed as new and desired to be protected by Letters Patent of the United States is:

1. A method for providing a three dimensional model based upon an instruction of a client, comprising the steps of:
storing a three dimensional object image data provided by said client;
extracting a three dimensional model image data from said object image data;
producing said three dimensional model with said model image data; and
providing said client with said three dimensional model.

2. The method of claim 1 wherein said instruction specifies a purpose for said model.

3. The method of claim 1 wherein said instruction specifies a use for said model.

4. The method of claims 2 or 3 wherein said instruction further specifies a use for medical purposes.

5. The method of claim 1 wherein said instruction specifies a region to be modeled.

6. The method of claim 1 wherein said instruction specifies a quality of material for said model.

7. The method of claim 1 wherein said instruction specifies a color for said model.

8. The method of claim 1 wherein said instruction specifies another model previously requested by said client.

9. The method of claim 1 wherein said producing is performed by one of the methods selected from the group comprising, laser photo lithography, selective laser sintering, fused deposition and rapid prototyping.

10. The method of claim 1 wherein said three dimensional object image data provided by said client is provided via a network.

11. The method of claim 1 wherein said object image data is an animate body.

12. The method of claim 1 wherein said object image data is an inanimate body.

13. The method of claim 1 further comprising the step of providing said client with a progress report of said model.

14. The method of claim 1 wherein said extraction of said model image data is performed by an image analysis provider.

15. A method for providing a three dimensional model based upon an instruction of a client, comprising the steps of:
storing a three dimensional object image data provided by said client;
extracting a three dimensional model image data from said object image data;
providing a three dimensional model provider with said model image data for producing said three dimensional model with said model image data; and
providing said client with said three dimensional model.

16. The method of claim 15 wherein said instruction specifies a purpose for said model.

17. The method of claim 15 wherein said instruction specifies a use for said model.

18. The method of claims 16 or 17 wherein said instruction further specifies a use for medical purposes.

19. The method of claim 15 wherein said instruction specifies a region to be modeled.

20. The method of claim 15 wherein said instruction specifies a quality of material for said model.

21. The method of claim 15 wherein said instruction specifies a color for said model.

22. The method of claim 15 wherein said instruction specifies another model previously requested by said client.

23. The method of claim 15 wherein said producing is performed by one of the methods selected from the group comprising, laser photo lithography, selective laser sintering, fused deposition and rapid prototyping.

24. The method of claim 15 wherein said three dimensional object image data provided by said client is provided via a network.

25. The method of claim 15 wherein said object image data is an animate body.

26. The method of claim 15 wherein said object image data is an inanimate body.

27. The method of claim 15 further comprising the step of providing said client with a progress report of said model.

28. The method of claim 15 wherein said extraction of said model image data is performed by an image analysis provider.

29. A method for providing a three dimensional model based upon an instruction of a client, comprising the steps of:
receiving a three dimensional object image data from said client;
providing an image analysis provider with said object image data for extracting a three dimensional model image data from said object image data;
providing a three dimensional model provider with said model image data for producing said three dimensional model with said model image data; and
providing said client with said three dimensional model.

30. The method of claim 29 wherein said instruction specifies a purpose for said model.

31. The method of claim 29 wherein said instruction specifies a use for said model.

32. The method of claims 30 or 31 wherein said instruction further specifies a use for medical purposes.

33. The method of claim 29 wherein said instruction specifies a region to be modeled.

34. The method of claim 29 wherein said instruction specifies a quality of material for said model.

35. The method of claim 29 wherein said instruction specifies a color for said model.

36. The method of claim 29 wherein said instruction specifies another model previously requested by said client.

37. The method of claim 29 wherein said producing is performed by one of the methods selected from the group comprising, laser photo lithography, selective laser sintering, fused deposition and rapid prototyping.

38. The method of claim 29 wherein said three dimensional object image data provided by said client is provided via a network.

39. The method of claim 29 wherein said object image data is an animate body.

40. The method of claim 29 wherein said object image data is an inanimate body.

41. The method of claim 29 further comprising the step of providing said client with a progress report of said model.

42. A method for providing a three dimensional model based upon an instruction of a client, comprising the steps of:
imaging a three dimensional object to obtain a three dimensional object image data;
storing said three dimensional object image data;
extracting a three dimensional model image data from said object image data;
producing said three dimensional model with said model image data; and
providing said client with said three dimensional model.

43. The method of claim 42 wherein said instruction specifies a purpose for said model.

44. The method of claim 42 wherein said instruction specifies a use for said model.

45. The method of claims 43 or 44 wherein said instruction further specifies a use for medical purposes.

46. The method of claim 42 wherein said instruction specifies a region to be modeled.

47. The method of claim 42 wherein said instruction specifies a quality of material for said model.

48. The method of claim 42 wherein said instruction specifies a color for said model.

49. The method of claim 42 wherein said instruction specifies another model previously requested by said client.

50. The method of claim 42 wherein said producing is performed by one of the methods selected from the group comprising, laser photo lithography, selective laser sintering, fused deposition and rapid prototyping.

51. The method of claim 42 wherein said three dimensional object image data provided by said client is provided via a network.

52. The method of claim 42 wherein said object image data is an animate body.

53. The method of claim 42 wherein said object image data is an inanimate body.

54. The method of claim 42 further comprising the step of providing said client with a progress report of said model.

55. The method of claim 42 wherein said extraction of said model image data is performed by an image analysis provider.

56. A method for providing a three dimensional model based upon an instruction of a client, comprising the steps of:
storing a three dimensional object image data provided by said client;
extracting a three dimensional model image data from said object image data; and
providing said client with said model image data.

57. The method of claim 56 wherein said instruction specifies a purpose for said model.

58. The method of claim 56 wherein said instruction specifies a use for said model.

59. The method of claims 57 or 58 wherein said instruction further specifies a use for medical purposes.

60. The method of claim 56 wherein said instruction specifies a region to be modeled.

61. The method of claim 56 wherein said instruction specifies a quality of material for said model.

62. The method of claim 56 wherein said instruction specifies a color for said model.

63. The method of claim 56 wherein said instruction specifies another model previously requested by said client.

64. The method of claim 56 wherein said producing is performed by one of the methods selected from the group comprising, laser photo lithography, selective laser sintering, fused deposition and rapid prototyping.

65. The method of claim 56 wherein said three dimensional object image data provided by said client is provided via a network.

66. The method of claim 56 wherein said object image data is an animate body.

67. The method of claim 56 wherein said object image data is an inanimate body.

68. The method of claim 56 further comprising the step of providing said client with a progress report of said model.

69. The method of claim 56 wherein said extraction of said model image data is performed by an image analysis provider.

70. A method for providing a three dimensional model based upon an instruction of a client, comprising the steps of:
receiving a three dimensional object image data from a client;
providing an image analysis provider with said object image data for extracting a three dimensional model image data from said object image data; and
providing said client with said model image data.

71. The method of claim 70 wherein said instruction specifies a purpose for said model.

72. The method of claim 70 wherein said instruction specifies a use for said model.

73. The method of claims 71 or 72 wherein said instruction further specifies a use for medical purposes.

74. The method of claim 70 wherein said instruction specifies a region to be modeled.

75. The method of claim 70 wherein said instruction specifies a quality of material for said model.

76. The method of claim 70 wherein said instruction specifies a color for said model.

77. The method of claim 70 wherein said instruction specifies another model previously requested by said client.

78. The method of claim 70 wherein said producing is performed by one of the methods selected from the group comprising, laser photo lithography, selective laser sintering, fused deposition and rapid prototyping.

79. The method of claim 70 wherein said three dimensional object image data provided by said client is provided via a network.

80. The method of claim 70 wherein said object image data is an animate body.

81. The method of claim 70 wherein said object image data is an inanimate body.

82. The method of claim 70 further comprising the step of providing said client with a progress report of said model.

83. A method for providing a three dimensional model based upon an instruction of a client, comprising the steps of:
imaging a three dimensional object to obtain a three dimensional object image data;
storing said three dimensional object image data;
extracting a three dimensional model image data from said object image data; and
providing said client with said model image data.

84. The method of claim 83 wherein said instruction specifies a purpose for said model.

85. The method of claim 83 wherein said instruction specifies a use for said model.

86. The method of claims 84 or 85 wherein said instruction further specifies a use for medical purposes.

87. The method of claim 83 wherein said instruction specifies a region to be modeled.

88. The method of claim 83 wherein said instruction specifies a quality of material for said model.

89. The method of claim 83 wherein said instruction specifies a color for said model.

90. The method of claim 83 wherein said instruction specifies another model previously requested by said client.

91. The method of claim 83 wherein said producing is performed by one of the methods selected from the group comprising, laser photo lithography, selective laser sintering, fused deposition and rapid prototyping.

92. The method of claim 83 wherein said three dimensional object image data provided by said client is provided via a network.

93. The method of claim 83 wherein said object image data is an animate body.

94. The method of claim 83 wherein said object image data is an inanimate body.

95. The method of claim 83 further comprising the step of providing said client with a progress report of said model.

96. The method of claim 83 wherein said extraction of said model image data is performed by an image analysis provider.
